(19) United States
(12) Patent Application Publication
(10) Pub. No.: US 2006/0026434 A1
(43) Pub. Date: Feb. 2, 2006

(54) Image forming apparatus and image forming system

(75) Inventors: Eiichi Yoshida, Toyokawa-shi (JP); Toru Ichiki, Sagamihara-shi (JP); Hiroshi Iwamoto, Toyohashi-shi (JP); Masaaki Saka, Toyokawa-shi (JP); Shoji Imaizumi, Shinshiro-shi (JP); Hideki Hino, Toyokawa-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/969,193

(22) Filed: Oct. 21, 2004

(30) Foreign Application Priority Data
Jul. 27, 2004 (JP) 2004-218521

(51) Int. Cl. H04L 9/00

(52) U.S. Cl. 713/182

(57) ABSTRACT

An image forming apparatus (for example, MFP (Multi Function Peripheral)) comprises an authentication part which performs user authentication by communicating with an authentication server, a storing part which stores “use-permission-information” for setting permission and/or prohibition of use of the apparatus for each user, and a determining part which determines permission and/or prohibition of the use of the apparatus by a user authorized by the authentication part on the basis of the use-permission-information.

This application is based on application No. 2004-218521 filed in Japan, the contents of which are hereby incorporated by reference.

### BACKGROUND OF THE INVENTION

1. Field of the Invention

The present invention relates to an image forming apparatus such as a multifunction peripheral (abbreviated as MFP), and an image forming system having the image forming apparatus.

2. Description of the Background Art

There is an image forming apparatus such as a multifunction peripheral (MFP) which has a plurality of functions such as a copying function, a scanning function, a facsimile communication function and a printing function and which performs user authentication when used.

In recent years, there is also a system of performing user authentication, not by an apparatus itself, but by an authentication server connected to the apparatus (see, for example, Japanese Patent Laid-open No. 2003-337868). According to this technique, an operation of authenticating a user can be performed by the authentication server in a computer system.

This system, however, has a problem such that the system cannot be operated flexibly due to the following circumstances.

Concretely, the authentication server can store information regarding whether a user can be authenticated or not on a user-by-user unit basis but it is difficult for the server to store information regarding whether an image forming apparatus can be authenticated or not on an apparatus-by-apparatus unit basis. If the authentication information on the apparatus-by-apparatus basis is registered in the authentication server, a registration work for registering the authentication information on the apparatus-by-apparatus basis into the authentication server is necessary. Since various constraints are generally imposed on a setting registering operation in the authentication server from the viewpoint of security (for example, the number of authentication server administrators is limited), the load of the registering work on the authentication server administrator increases. In particular, in the case of managing a plurality of various kinds of apparatuses by the authentication server, since the apparatuses have functions different from each other, it is difficult to register permission information which varies according to apparatuses in the authentication server.

### SUMMARY OF THE INVENTION

An object of the present invention is to provide a technique capable of operating an image forming apparatus more flexibly while enabling user authentication using an authentication server to be performed.

In order to achieve the above object, according to a first aspect of the present invention, an image forming apparatus includes: an authentication part which performs user authentication by communicating with an authentication server; a storing part which stores use-permission-information for setting permission and/or prohibition of use of the image forming apparatus for each user; and a determining part which determines permission and/or prohibition of the use of the image forming apparatus by a user authorized by the authentication part on the basis of the use-permission-information stored in the storing part.

The image forming apparatus can be operated more flexibly while enabling the user authentication using the authentication server to be performed.

According to a second aspect of the present invention, an image forming apparatus includes: an authentication part which performs user authentication by communicating with an authentication server; a storing part which stores storage-location-information specifying at least one storing apparatus in which use-permission-information for setting permission and/or prohibition of use of the image forming apparatus for each user is stored; an acquiring part which acquires the use-permission-information by communication with the at least one storing apparatus specified on the basis of the storage-location-information; and a determining part which determines permission and/or prohibition of the use of the image forming apparatus by a user authorized by the authentication part on the basis of the use-permission-information acquired from the at least one storing apparatus.

The image forming apparatus can be operated more flexibly while enabling the user authentication using the authentication server to be performed.

The present invention is also directed to an image forming system and an image forming method.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a general configuration of an image forming system according to a first preferred embodiment;

FIG. 2 is an outside view of an MFP (Multi Function Peripheral);

FIG. 3 is a block diagram showing a configuration of the MFP;

FIG. 4 is a diagram showing a registration screen used for registering use-permission-information;

FIG. 5 is a diagram showing an example of a data table in which the use-permission-information is registered;

FIG. 6 is a flowchart showing an operation of the MFP;

FIG. 7 is a flowchart showing an operation of the MFP;

FIG. 8 is a flowchart showing an operation of an authentication server;

FIG. 9 is an operation diagram showing transmission/reception of information between the MFP and the authentication server;

FIG. 10 is a diagram showing a screen used for an operation of inputting user information;

FIG. 11 is a diagram showing a screen displaying failure in authentication;

FIG. 12 is a diagram showing a screen displaying success in authentication;

FIG. 13 is a diagram showing an example of operation performed in the case where a request of executing a printing function is made from a computer;

FIG. 14 is a schematic diagram showing a general configuration of an image forming system according to a second preferred embodiment;

FIG. 15 is a diagram showing an example of a data table in which identification information of an apparatus storing use-permission-information (storage-location-information) is registered;

FIG. 16 is an operation diagram showing transmission/reception of information among the MFP, the authentication server and setting servers;

FIG. 17 is a flowchart showing an operation of the MFP;

FIG. 18 is a flowchart showing an operation of the MFP;

FIG. 19 is a flowchart showing an operation of the MFP;

FIG. 20 is a diagram showing an example of a data table in which use-permission-information (third preferred embodiment) is registered;

FIG. 21 is a flowchart showing an operation of the MFP; and

FIG. 22 is a flowchart showing an operation of the MFP.

### DESCRIPTION OF THE PREFERRED EMBODIMENTS

Preferred embodiments of the present invention will be described below with reference to the drawings.

A. First Preferred Embodiment

A1. General Configuration

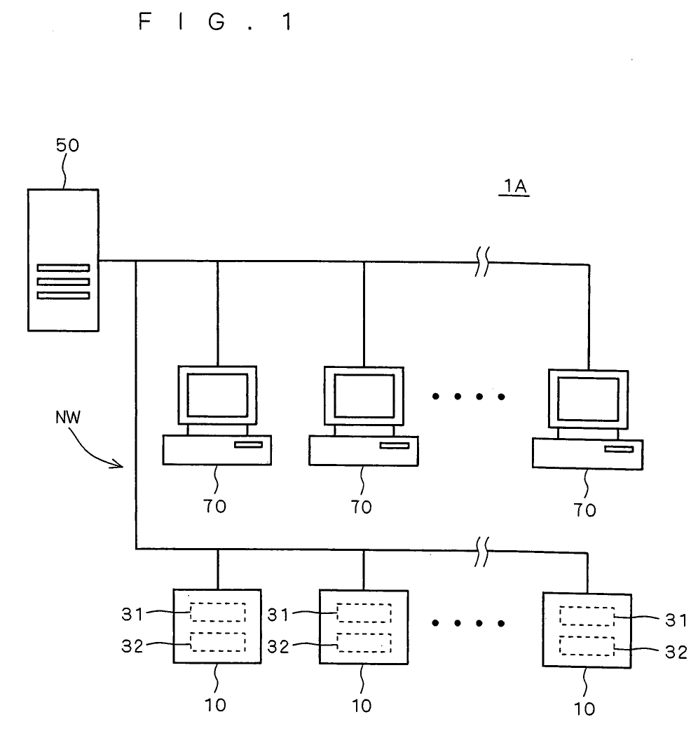

FIG. 1 is a schematic diagram showing a general configuration of an image forming system 1A according to a first preferred embodiment of the present invention. The system 1A has a plurality of multifunction peripherals (hereinafter, abbreviated as “MFPs”) 10 and an authentication server 50.

The MFP 10 is a multifunction apparatus having a scanning function, a copier (copying) function, a printing function, a facsimile communication function, an image storing function and the like. The MFP 10 is also expressed as an image forming apparatus having the function of forming an image.

The authentication server 50 transmits/receives data regarding authentication to/from the MFPs 10. The MFP 10 can determine whether the use is permitted to the use or not, that is, can perform user authentication by transmitting/receiving data regarding authentication to/from the authentication server 50.

The MFPs 10 and the authentication server 50 are connected to a network NW and can transmit/receive various kinds of data to/from each other via the network NW. Herein, the “network” is a communication line network performing data communications and, specifically, includes various communication line networks constructed by electric communication lines (including optical communication lines), such as LAN, WAN and the Internet. The form of connection to the network may be continuous connection using a dedicated line or the like or temporary connection such as dial-up connection using a public telephone line such as an analog line or a digital line (ISDN). The transmission system may be a wireless system or a wired system.

Further, a plurality of computers (clients) 70 are also connected to the server 50 via the network NW. The authentication server 50 is an authentication server in a system constructed by using the MFP 10 as a nucleus and is an authentication server in a computer system constructed by using the client computer 70 as a nucleus.

A2. MFP 10

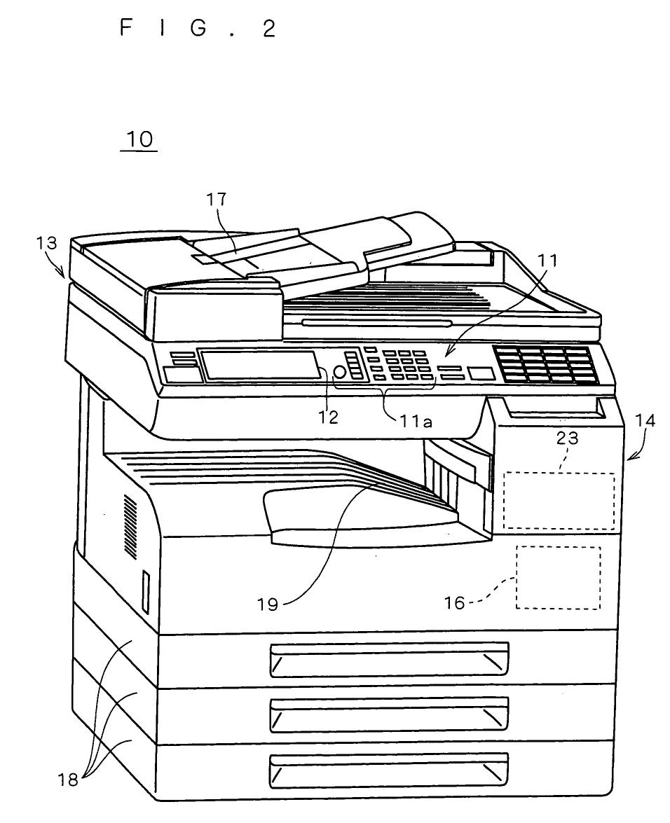

FIG. 2 is an outside view of the MFP 10.

The MFP 10 includes: an operation part 11 having a plurality of keys 11a and receiving various instructions by an operation of the user on the keys and an input of data such as characters and numerical numbers; a display 12 for displaying an instruction menu to the user, information regarding a captured image, and the like; a scanner part 13 for photoelectrically reading an original, thereby obtaining image data; and a printer part 14 for printing an image on a recording sheet on the basis of the image data.

The MFP 10 also includes: a feeder part 17 for feeding an original to the scanner part 13 on the top face of the body; a paper feeding part 18 for supplying a recording sheet to the printer part 14 in a lower portion; a tray 19, to which a recording sheet on which an image is printed by the printer part 14 is ejected, in a center portion; a communication part 16 for transmitting/receiving image data to/from an external device via a network on the inside, and a storing part 23 for storing image data and the like. Although not shown, the MFP 10 has a network interface, and the communication part 16 is connected to a network via the network interface so as to be able to transmit/receive various kinds of data to/from an external device.

The display 12 is used for various displays including authentication display, and the operation part 11 is used for various inputs including selection of functions. The display 12 is constructed as a liquid crystal panel having therein a touch sensor and the like, and a position touched with a finger of the user and the like can be detected. Therefore, the user can input various instructions by touching various virtual buttons or the like displayed in the display 12 with his/her finger or the like. The display 12 also has such an operation input function. The operation part 11 and the display 12 function as a main part of the user interface.

The scanner part 13 photoelectrically reads image information such as a picture, characters and a drawing from an original to obtain image data. The obtained image data (density data) is converted to digital data by a image processing part (not shown), is subjected to known various imaging processes, and is sent to the printer part 14 or the communication part 16 so as to be used for printing an image or transmitting data or stored in the storing part 23.

The printer part 14 prints an image onto a recording sheet on the basis of image data obtained by the scanner part 13, image data received from an external device by the communication part 16, or image data stored in the storing part 23. The printer part 14 is, therefore, a printing and outputting part for performing various printing and outputting operations.

The communication part 16 transmits/receives data via a network such as a LAN or the Internet by using an e-mail or the like to/from an external device connected to the network and, also, transmits/receives facsimile data via a public telephone line.

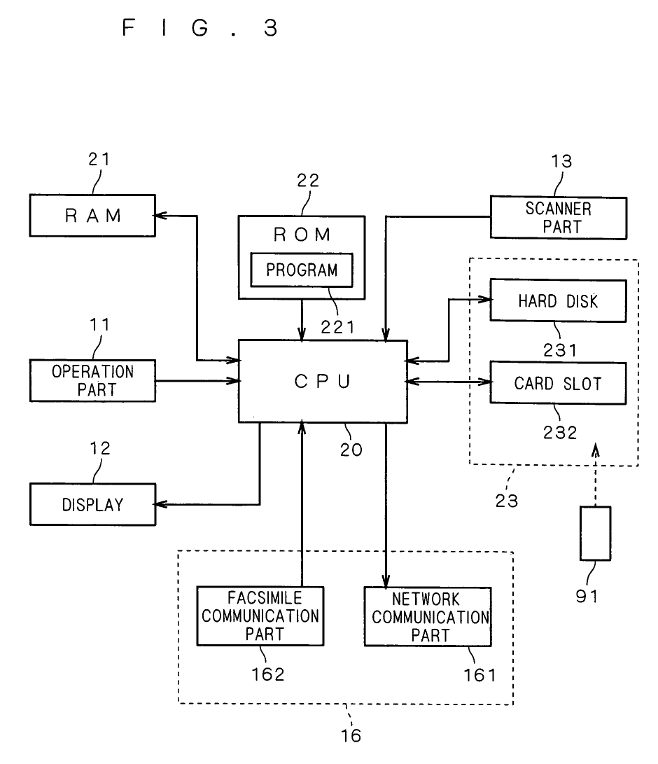

FIG. 3 is a block diagram mainly showing a part related to the first preferred embodiment in the configuration of the MFP 10. The MFP 10 includes a CPU 20 for performing various computing processes and controlling the general operation of the MFP 10. A RAM 21 for storing various kinds of data and a ROM 22 for storing a predetermined software program (hereinafter, simply referred to as “program”) 221 are connected to the CPU 20. To the CPU 20, the operation part 11, the display 12, the scanner part 13, the storing part 23 and the like are also connected. The storing part 23 is constructed by a hard disk 231 for storing image data and the like and a card slot 232 for reading information from a memory card 91. The RAM 21 is a nonvolatile RAM.

With the configuration, various kinds of data can be transmitted/received among the RAM 21, the scanner part 13, the hard disk 231 and the memory card 91 inserted in the card slot 232 under control of the CPU 20. On the display 12, information stored in the RAM 21, the hard disk 231 and the memory card 91 is displayed under control of the CPU 20.

The communication part 16 is also connected to the CPU 20. The communication part 16 has: a network communication part 161 (FIG. 3) for transmitting/receiving data by using an E-mail or the like via a network such as a LAN and the Internet to/from an external device connected to the network; and a facsimile communication part 162 (FIG. 3) for transmitting/receiving facsimile data via a public telephone line.

As shown in FIG. 1, the MFP 10 also includes an authentication part 31 and an operation permission determining part 32. Those parts are processing parts of which functions are realized by executing the program 212 by using hardware resources such as the CPU 20, the RAM 21, the ROM 22 and the storing part 23. The authentication part 31 performs user authentication by transmitting/receiving data to/from the authentication server 50. The operation permission determining part 32 determines whether the use of the MFP 10 by the user is permitted or not on the basis of “use-permission-information” (which will be described later).

As described above, the MFP 10 has a plurality of functions (operation functions): the copying function, the scanning function, the facsimile communication function, the printing function and the memory storing function.

Herein, the copying function is a function of copying an original on a document glass and outputting the data to a paper medium. The scanning function is a function of reading an original on the document glass as image data and transferring the generated image data to a predetermined storing part or the like. The generated image data is, for example, transferred and stored into a storing part in a desired computer 70. The facsimile communication function is a function of reading an original on the document glass, generating image data, and transmitting the image data to a destination by facsimile communication. The printing function is a function of outputting print data based on data in the storing part in the computer 70, data in the hard disk 231 of the MFP 10, and the like. The memory storing function is a function of storing generated image data in the hard disk 231 of the MFP 10. As will be described later, the use of the plurality of functions is partially or entirely limited according to users.

The scanning function, the facsimile communication function, the printing function and the memory storing function are also referred to as a scanning and transmitting function, a FAX transmitting function, a printer function, and an HDD storing function, respectively.

In this preferred embodiment, data for user authentication is stored in the authentication server 50 and information regarding use permission (also referred to as “use-permission-information” or “use-limit-information”) for each of the MFPs 10 is stored in the respective MFP 10 (for example, in the nonvolatile RAM 21). Specifically, by a registering work using the MFP 10, the use-permission-information of the MFP 10 is set for each user and stored in the MFP 10. Permission and/or prohibition (hereinafter, also simply described as “permission/prohibition”) of the use of the MFP 10 is determined by not only performing the user authentication by the authentication server 50 but also using the use-permission-information in the MFP 10. That is, authentication on a “person” is performed by using the user authentication and authentication on an “apparatus” is also performed by using the use-permission-information.

Since the use-permission-information of each MFP 10 is stored in the MFP 10 itself, as compared with the case of setting use permission only by user authentication using user information in the authentication server 50, settings for each MFP 10 can be determined more flexibly. Particularly, a setting registering operation for the MFP 10 can be performed by not the administrator of the general system (for example, an authentication server administrator) but the administrator of each MFP 10, so that the burden on the administrator of the general system can be lessened.

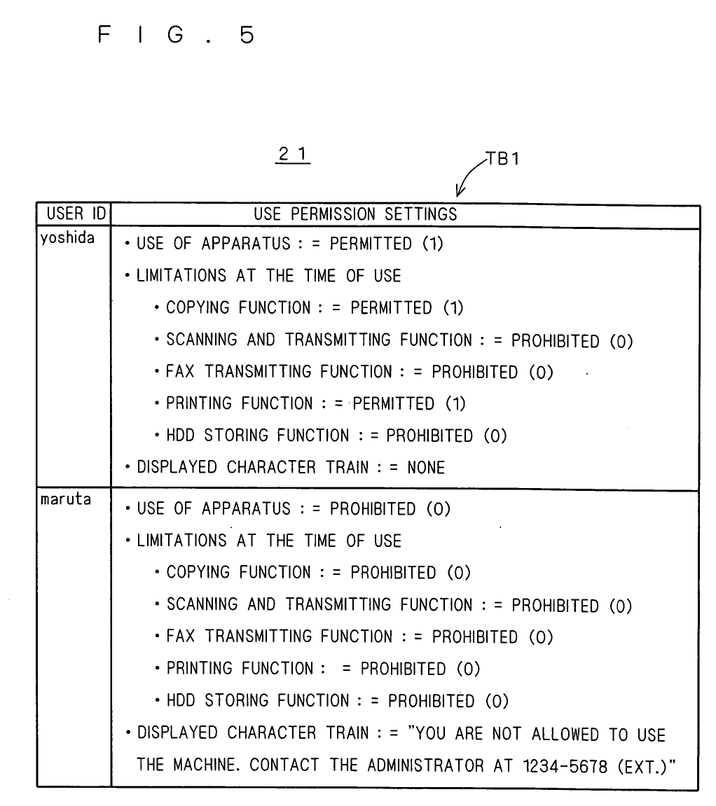

The “use-permission-information” (see FIG. 5) includes information regarding whether the use of the apparatus is generally (basically) permitted or not (limited or not), in other words, whether the use of the whole apparatus is permitted on the apparatus-by-apparatus unit basis or not (also referred to as “basic-limitation-information” or “permission-information-by-apparatus”). The “use-permission-information” also includes information regarding whether the use of each of functions of an apparatus (the use on a function-by-function unit basis) is permitted or not (limited or not) (also referred to as “function-limit-information” or “permission-information-by-function”).

The “permission-information-by-function” includes setting information regarding permission/prohibition of the use of the copying function (“copy function permission information”), setting information regarding permission/prohibition of the use of the scanning function (“scanning function permission information”), setting information regarding permission/prohibition of the use of the facsimile communication function (“facsimile communication function permission information”), setting information regarding permission/prohibition of the use of the printing function (“printing function permission information”), and setting information regarding permission/prohibition of the use of the storing function (“storing function permission information”). The “copying function permission information”, the “scanning function permission information”, the “facsimile communication function permission information”, the “printing function permission information” and the “storing function permission information” can be also referred to as “copying function limitation information”, “scanning function limitation information”, “facsimile communication function limitation information”, “printing function limitation information” and “storing function limitation information”, respectively.

By setting the “permission-information-by-apparatus” in the “use-permission-information”, permission/prohibition of the use of a whole apparatus can be set by the administrator or the like of the apparatus more flexibly.

By setting the “permission-information-by-function” in the “use-permission-information”, permission/prohibition of the use of each of the functions of an apparatus can be set more flexibly by the administrator or the like of the apparatus. In particular, by setting the use-permission-information on the function-by-function unit basis of the MFP 10 in addition to (or in place of) setting of the use-permission-information of all of the functions of the MFP 10, the setting can be made more flexibly. In other words, by setting the permission/prohibition of the use of the MFP 10 function by function, the setting can be made more flexibly.

In the case where the setting of the “permission-information-by-apparatus” and that of the “permission-information-by-function” are mutually contradictory, it is sufficient to properly determine the priority order and determine the permission/prohibition of the use function by function can be permitted or not. It is assumed herein that priority is given to setting of “prohibition of use” in both of the information. Specifically, in the case where “prohibition of the use” is set in either the “permission-information-by-function” or the “permission-information-by-apparatus” of a certain function, the use of at least the function is prohibited. In other words, only in the case where the “permission of the use” is set in both of the “permission-information-by-function” and the “permission-information-by-apparatus” of a certain function, the use of the function is permitted.

As described above, in the image forming system 1A, the user authentication operation using the authentication server 50 can be performed and, in addition, an operation of giving permission of the use (which can be also expressed as a kind of authentication operation) on the apparatus unit basis (further, on the basis of each of functions of an apparatus) can be performed on the basis of the “use-permission-information” stored in each of the MFPs 10. Thus, the system can be operated more flexibly.

The operation of such a system will be described in detail below.

A3. Operation

Registration of User Authentication Information into Authentication Server 50

In the authentication server 50, information in which a user ID and a user password of the user ID are associated with each other (user authentication information) is stored. For example, user ID=“yoshida” and a user password “xyss1556” for the user ID are associated with each other and stored. User ID=“maruta” and a user password “ss11224abc” of the user ID are associated with each other and stored.

An operation of registering the user authentication information into the authentication server 50 is performed by the administrator of the system.

Registration of Use-Permission-Information to MFP 10

Registration of the use-permission-information to the MFP 10 will now be described.

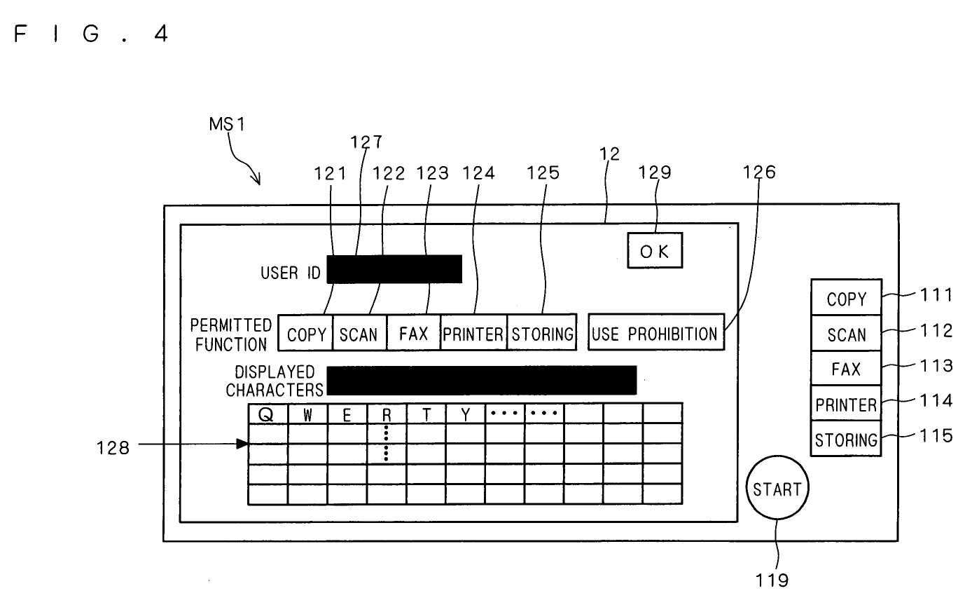

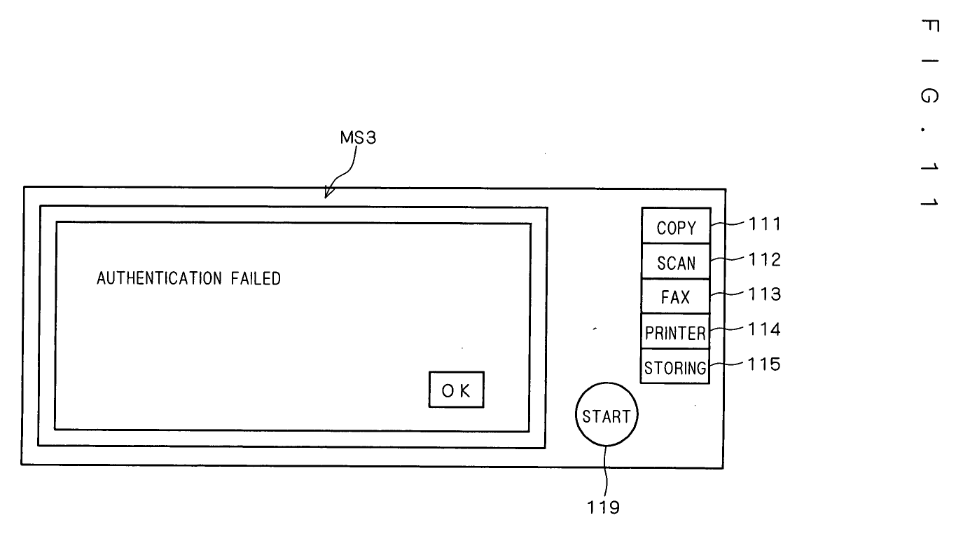

FIG. 4 is a diagram showing a registration screen MS1 used at the time of registering the use-permission-information in the MFP 10. The screen MS1 is a screen for an administrator and is displayed on the display 12 when authentication of the administrator is satisfied (succeeds). An authenticating operation by the administrator is performed by entering administrator ID and an administrator password as user ID and a user password on an initial screen MS2 (see FIG. 10) in an initial state after activation of the MFP 10.

The screen MS1 includes virtual various buttons and the like. Concretely, the screen MS1 includes a copy permission setting button 121, a scan permission setting button 122, a FAX permission setting button 123, a printing permission setting button 124, a storage permission setting button 125, a use prohibition setting button 126, a user ID entry box 127, a software keyboard 128 and an OK button 129.

The administrator of the MFP 10 sets the use-permission-information of the MFP 10 (which includes, more specifically, use-permission-information-by-function) for each user as follows.

First, the user ID of a user to be registered is entered to the entry box 127 by using the software keyboard 128, thereby specifying the user to be set. Next, the permission/prohibition of the use of each of the functions by the target user is set. For example, in the case of permitting the copying function and the printing function and prohibiting the use of the scanning function, the facsimile communication function and the storing function, the copy permission setting button 121 and the print permission setting button 124 are clicked to permit the use of only the two functions and, in such a state, the OK button 129 is clicked. In the case of prohibiting the use of the whole MFP 10, it is sufficient to click the OK button 129 in a state where only the use prohibition setting button 126 is clicked. In the other cases, functions are set in a manner similar to the above.

By the operation, a data table TB1 including the registration data as shown in FIG. 5 is stored in the nonvolatile RAM 21. FIG. 5 is a diagram showing an example of registration in the data table TB1 and shows a registration state of two persons.

For example, for the user ID “yoshida”, flag information (“permission-information-by-apparatus”) indicating whether the use of the apparatus is basically permitted or not is set as “1” (indicative of “permission”) and the use-permission-information-by-function (“permission-information-by-function”) is set as follows. Concretely, each of the flag information corresponding to the copying function and the flag information corresponding to the printing function is set to “1” (indicative of “permission”) so that the use of both of the functions is permitted. Each of flag information corresponding to the scanning function, facsimile communication function, and storing function is set to “0” (indicative of “prohibition”) and the use of the functions is prohibited.

For the user ID “maruta”, the flag information indicating whether the use of the apparatus is basically permitted or not is set to “0” (indicative of “prohibition”) and prohibition of the use of the MFP 10 is set for the user. For example, by setting the “permission-information-by-apparatus” in the MFP 10 to “0” (prohibition) while maintaining the user authentication information in the authentication server 50, the use of the MFP 10 by the user can be temporarily prohibited. Concretely, the use by a user who is in a business trip for a short period can be prohibited, so that abuse by an outsider while the user is in the business trip can be prevented.

Although the case where the flag information indicative of permission/prohibition of the use of each of the other functions is automatically set to “0” (“prohibition”) in response to the setting of prohibition is shown herein, the present invention is not limited thereto. In a state where the flag information indicating permission/prohibition of the use of each function is individually set, the “permission-information-by-apparatus” may be also separately set. In this manner, only by resetting the “permission-information-by-apparatus” to “1” (“permission”), permission/prohibition of the use on the function-by-function unit basis can be set by using the flag information indicative of permission/prohibition of the use of each of the other functions.

The registering operation is performed by the administrator of each of the MFPs 10.

Using Operation

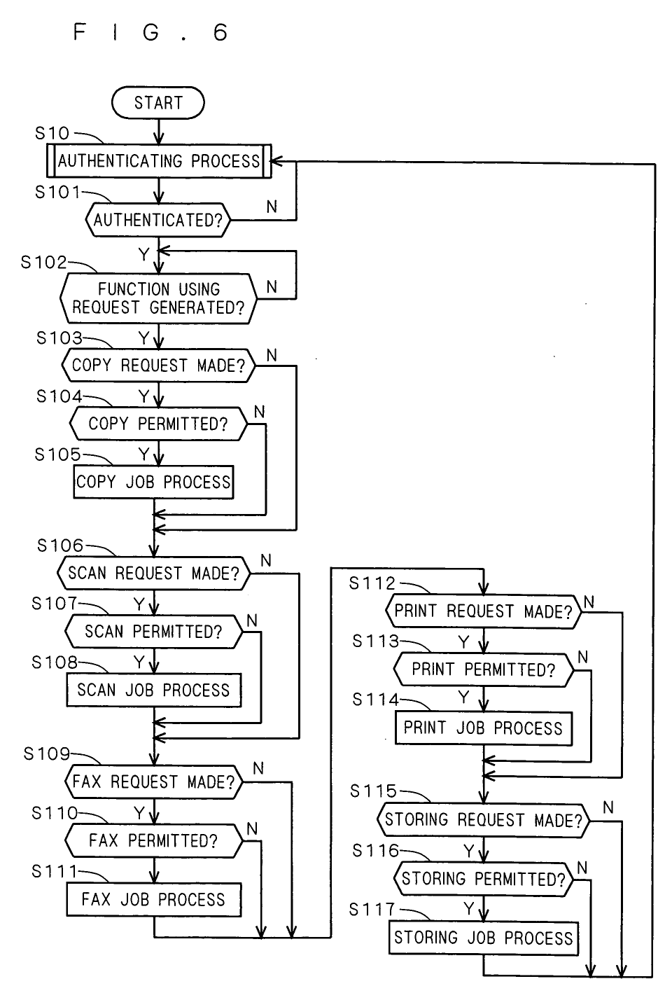

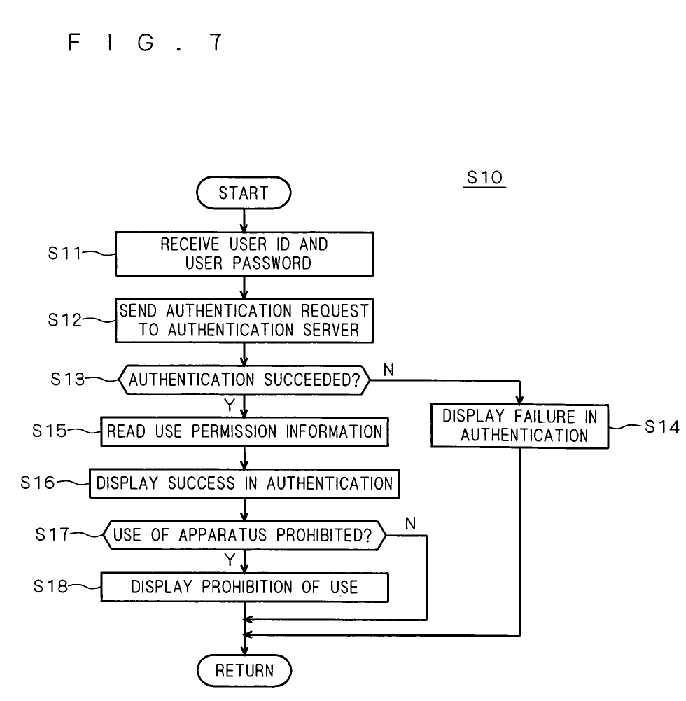

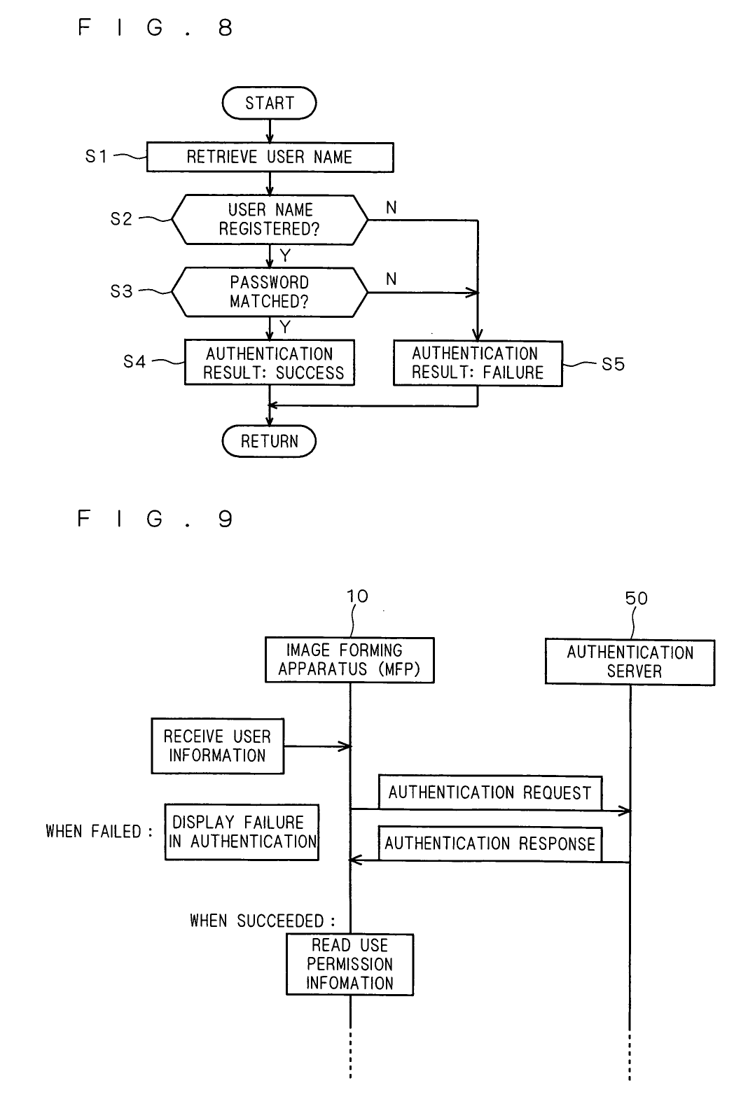

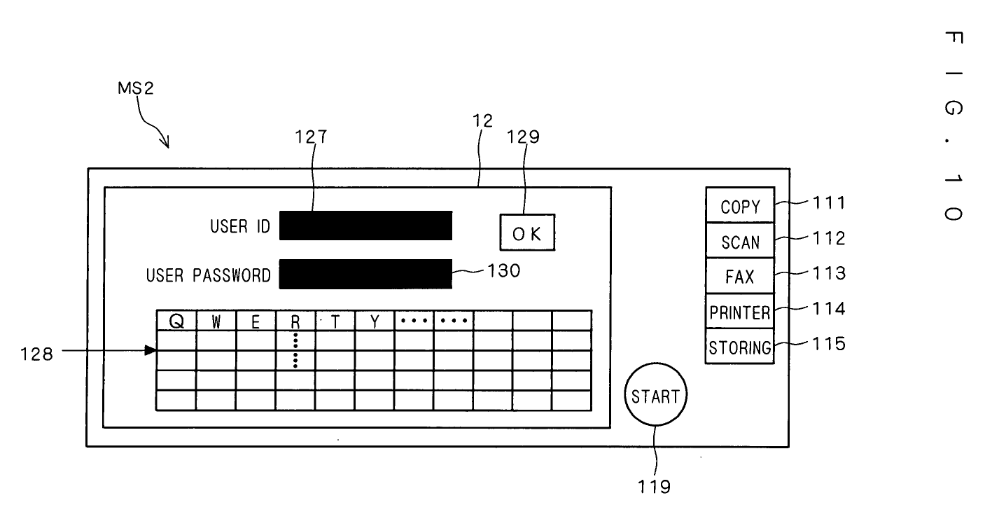

The operation performed when the user actually uses various functions (the copying function and the like) of the MFP 10 will now be described with reference to FIGS. 6 to 9. FIGS. 6 and 7 are flowcharts showing the operation of the MFP 10. FIG. 8 is a flowchart showing the operation of the authentication server 50 at the time of user authentication. FIG. 9 is an operation diagram showing transmission/reception of information (data) between the MFP 10 and the authentication server 50.

First, in step S10 (FIG. 6), an authenticating operation is performed. The details of the authenticating operation will be described with reference to FIGS. 7 to 9. FIG. 7 is a flowchart showing the detailed operation of the MFP 10 in step S10.

In step S11 (FIG. 7), an input of user ID and a user password is accepted.

FIG. 10 is a diagram showing the screen MS2 used for the input operation. The screen MS2 is provided with the software keyboard 128, the OK button 129, the user ID entry box 127 and a user password entry box 130.

The user enters the user ID (also referred to as “input user ID”) into the user ID entry box 127 by using the software keyboard 128, touches the user password entry box 130 with a finger to make the entry box 130 selected, and enters the user password (also referred to as “input user password”) into the user password entry box 130 by using the software keyboard 128. The user finally clicks the OK button 129.

On receipt of the input from the user, the MFP 10 transmits an “authentication request” to the authentication server 50 (step S12 in FIG. 7). The “authentication request” includes instruction data requesting authentication and, in addition, user information to be authenticated (concretely, the input user ID and the input user password). The IP address (for example, 192.168.0.10) of the authentication server 50 is stored in the MFP 10 and the MFP 10 determines the authentication server 50 on the basis of the IP address.

The authentication server 50 receives the “authentication request” and performs the authenticating operation. The authentication server 50 checks the input user ID and the input user password sent from the MFP 10 against the user authentication information stored in the authentication server 50 and determines whether the user is an authorized user or not (also see FIG. 9).

Concretely, as shown in FIG. 8, the authentication server 50 retrieves the input user ID from a data table in which the user authentication information is stored (step S1). When the authentication server 50 recognizes that the input user name is stored in the user authentication information (step S2) and confirms that the input user password coincides with the corresponding password in the user authentication information (step S3), the authentication server 50 determines that the authentication succeeds (success) (step S4). In the other cases, the authentication server 50 determines that the authentication fails (failure) (step S5). The authentication server 50 sends the authentication result (success or failure) to the MFP 10. That is, an authentication response (see FIG. 9) is made.

The MFP 10 receives the authentication result and performs a branching process (step S13). When the authentication fails, the MFP 10 advances to step S14. When the authentication succeeds, the MFP 10 advances to step S15.

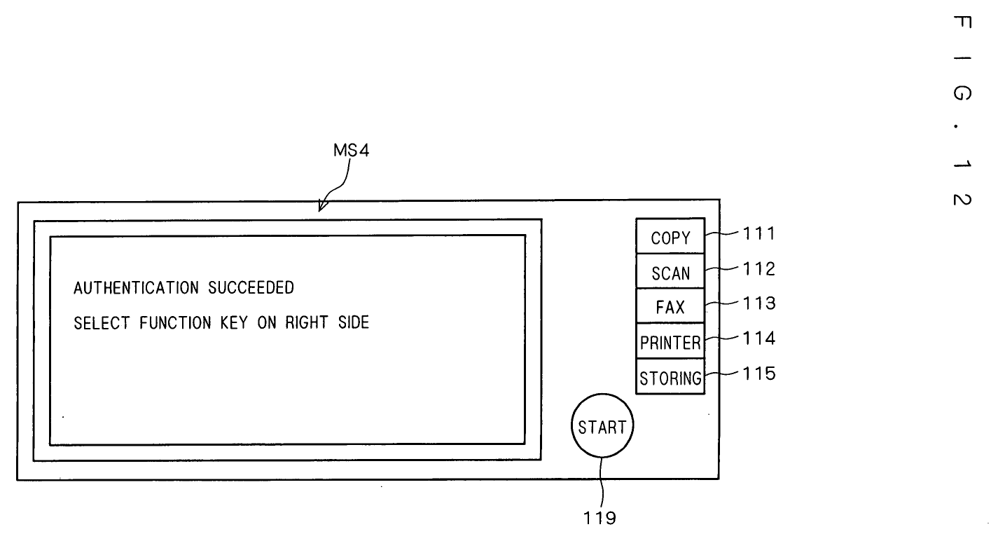

In step S14, as shown in FIG. 11, the MFP 10 displays a screen MS3 including characters such as “authentication failed” on the display 12 to notify the user of failure in authentication.

In step S15, the MFP 10 retrieves the use-permission-information of the authenticated user from the RAM 21. By setting flag information specifying the use conditions of the MFP 10 at the present time point on the basis of data regarding the read use-permission-information, the use conditions of the user are set. Concretely, on the basis of the “permission-information-by-apparatus” indicative of the permission/prohibition of the basic use of the MFP 10, flag information specifying the use conditions on the apparatus unit basis of the MFP 10 is set. The flag information specifying the use conditions for each of the functions of the MFP is set on the basis of the “permission-information-by-function” indicative of the permission/prohibition of the use on the function unit basis of the MFP 10. For example, as shown in FIG. 5, to the user having the authenticated user ID “yoshida”, the use of the copying function and the printing function is permitted and the use of the scanning function, the facsimile communication function and the storing function is prohibited on the basis of the “use-permission-information” in the data table TB1 in the MFP 10.

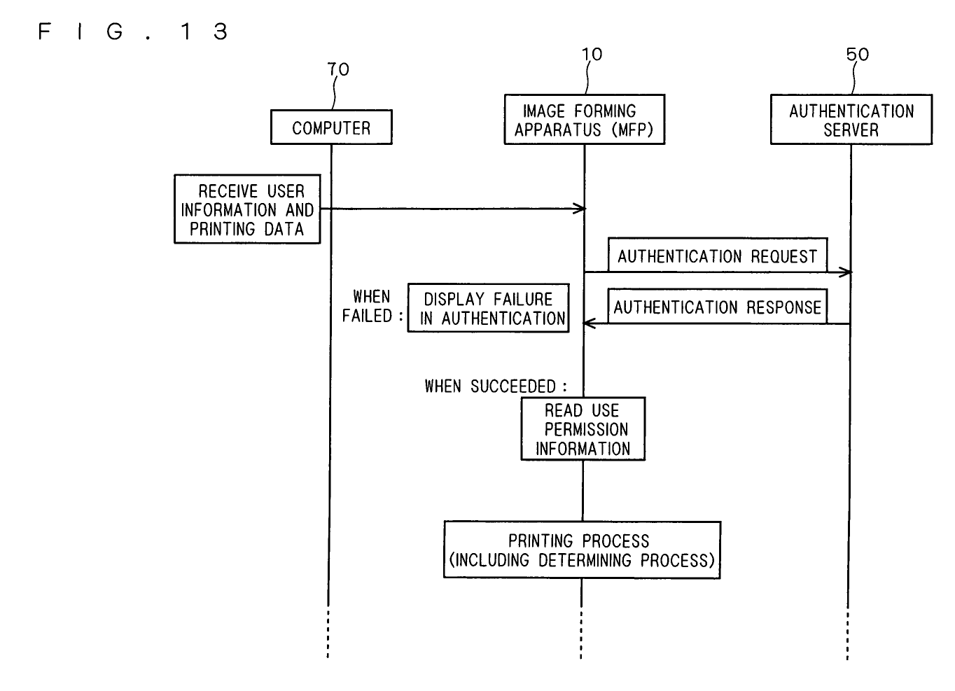

In step S16, as shown in FIG. 12, the MFP 10 displays a screen MS4 including characters such as “authentication succeeded” on the display 12 to notify the user of success in authentication. On the screen MS4, a message to urge the user to select a desired function is displayed. The user clicks any of function selection buttons 111 to 115 in the display, thereby selecting the desired function.

In step S17, whether the use of the MFP 10 is prohibited on the apparatus unit basis or not is determined by referring to the information read in step S15. In the case where an apparatus use flag is set to “0” (prohibited), the MFP 10 advances to step S18. In the case where the apparatus use flag is set to “1” (permitted), the MFP 10 finishes the subroutine and advances to step S101 (FIG. 6).

In step S18, the MFP 10 displays a screen including characters such as “You are not allowed to use the machine. Contact the administrator at 1234-5678 (ext.)” (not shown) on the display 12. The use prohibition is notified to the user by such a screen indicating use prohibition.

After the user authentication and the use-permission-information are obtained as described above, the MFP 10 shifts to a state where any of a plurality of functions can be executed.

As described above, the MFP 10 has a function which is permitted to be used and a function which is prohibited to be used in the plurality of functions. The MFP 10 determines whether each of the functions (function operations) is actually executed or not in accordance with the use conditions set in step S15 (steps S102 to S116 in FIG. 6).

Referring again to FIG. 6, after the process of step S10 is finished, whether authentication has been made in step S101 or not is determined. Only in the case where authentication has been made, the MFP 10 advances to step S102. In the other cases, the MFP 10 returns to step S10. In step S101, when the user authentication has succeeded and the use of the whole apparatus is permitted, it is regarded that the authentication has succeeded. In other words, only when it is confirmed that the user authentication succeeds and that the use of the whole apparatus is not prohibited, the MFP 10 advances to step S102.

In step S102, the MFP 10 waits until a request for the use of any of functions is generated (in other words, until any of the functions is selected). After the use request is generated, the MFP 10 advances to step S103 and subsequent steps.

In step S103 and subsequent steps, first, a function selected by clicking one of the function selection buttons 111 to 115 is determined (steps S103, S106, S109, S112 and S115). Only when it is determined that the use of the selected function is permitted at the present time point (steps S104, S107, S110, S113 and S116), the function is executed in practice (steps S105, S108, S111, S114 and S117).

Concretely, when the copy function selection button 111 out of the function selection buttons 111 to 115 is clicked, it is determined in step S103 that a request to use the copying function is accepted. In this case, whether the use of the copying function is permitted or not is determined (step S104). Only when the use is permitted, an actual copy job process is performed (step S105).

In the case where the scan function selection button 112 out of the function selection buttons 111 to 115 is clicked, it is determined in step S106 that a request to use the scan function is accepted. In this case, whether the use of the scan function is permitted or not is determined (step S107). Only when the use is permitted, an actual scan job process is performed (step S108).

Further, in the case where the facsimile communication function selection button 113 out of the function selection buttons 111 to 115 is clicked, in step S109, it is determined that the request to use the facsimile communication function is accepted. In this case, whether the use of the facsimile communication function is permitted or not is determined (step S110). Only when the use is permitted, an actual facsimile communication job process is performed (step S111).

Further, in the case where the printing function selection button 114 out of the function selection buttons 111 to 115 is clicked, in step S112, it is determined that the request to use the printing function is accepted. In this case, whether the use of the printing function is permitted or not is determined (step S113). Only when the use is permitted, an actual print job process is performed (step S114).

Further, in the case where the storing function selection button 115 out of the function selection buttons 111 to 115 is clicked, in step S115, it is determined that the request to use the storing function is accepted. In this case, whether the use of the storing function is permitted or not is determined (step S116). Only when the use is permitted, an actual storing job process is performed (step S117).

In steps S105, S108, S111, S114 and S117, the user inputs required information in accordance with various instructions displayed on the display 12, and the MFP 10 executes a function in accordance with the contents of an input on the basis of the input information. For example, in step S105, the user performs an operation of designating the number of copies, the copy size, and the like and the MFP 10 executes an actual copying operation in accordance with the designation.

In such a manner, the MFP 10 is used by the user.

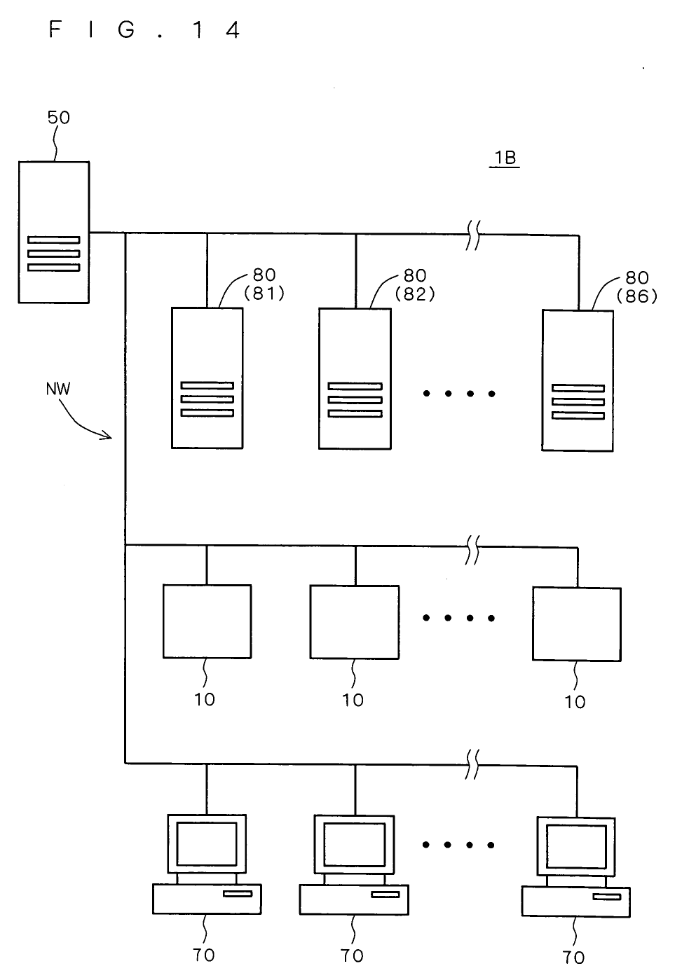

Although the case of executing the printing function or the like by using the user interface of the MFP 10 has been described above, the printing function can be also executed by the computer 70 connected to the network. FIG. 13 is a diagram showing an example of an operation performed in the case of executing a request for executing the printing function from the network-connected computer 70.

Concretely, as shown in FIG. 13, when a software program of a printer driver or the like is executed by the computer 70, a screen for requesting an input of user information is displayed on the display of the computer 70. In response to the screen, the user inputs user information (the user ID and user password) by using the computer 70.

The computer 70 transmits both of the input user information and print data to be printed to the MFP 10. The MFP 10 transfers the user information to the authentication server 50 and makes an authentication request. The authentication server 50 performs an authenticating operation similar to the above and sends back the result of authentication to the MFP 10.

Subsequently, based on the result of authentication, operations similar to the above (steps S13 to S18 and S101 to S117) are performed. Concretely, when the user authentication succeeds, the use-permission-information of the user is read (step S15) and success in authentication is displayed (step S16). After that, when it is recognized in step S17 that the use on the “apparatus” unit basis is permitted, the MFP 10 advances to step S102. In steps S102 and S112, it is determined that the function use request (more specifically, the request for using the printing function) is accepted. Further, whether the use of the printing function is permitted or not is determined (step S113) and an actual printing job process is performed only when the use is permitted (step S114).

In such a manner, the printing function can be also executed from the computer 70.

As described above, the system 1A according to this preferred embodiment can perform user authentication by using the authentication server 50. Therefore, the benefit of relatively stringent management by the authentication server 50 can be received. By using a user authentication server in a computer system also as a user authentication server in an image forming system, the management cost of the certification system on the user unit basis can be reduced.

In the system 1A according to this preferred embodiment, permission/prohibition of the use of each of the MFPs 10 can be determined on the basis of the “use-permission-information” stored in the storing part in the MFP 10. Thus, the system 1A can be operated more flexibly.

B. Second Preferred Embodiment

In the first preferred embodiment, the case of setting the use conditions of an MFP 10 on the basis of the use-permission-information stored in the MFP 10 has been described. In a second preferred embodiment, the case where the use-permission-information itself is not stored in the MFP 10 but information of the location of storage of the use-permission-information is stored in the MFP 10 will be described. In this case, the MFP 10 stores information of the location of storage for specifying an apparatus storing the use-permission-information (for example, an IP address of a server 80 (which will be described later) as an apparatus storing the information) in the MFP 10. The MFP 10 receives the use-permission-information by communication with the apparatus storing information on the basis of the information of the location of storage, and determines permission/prohibition of the use of the MFP 10 on the apparatus-by-apparatus unit basis or on the function-by-function unit basis.

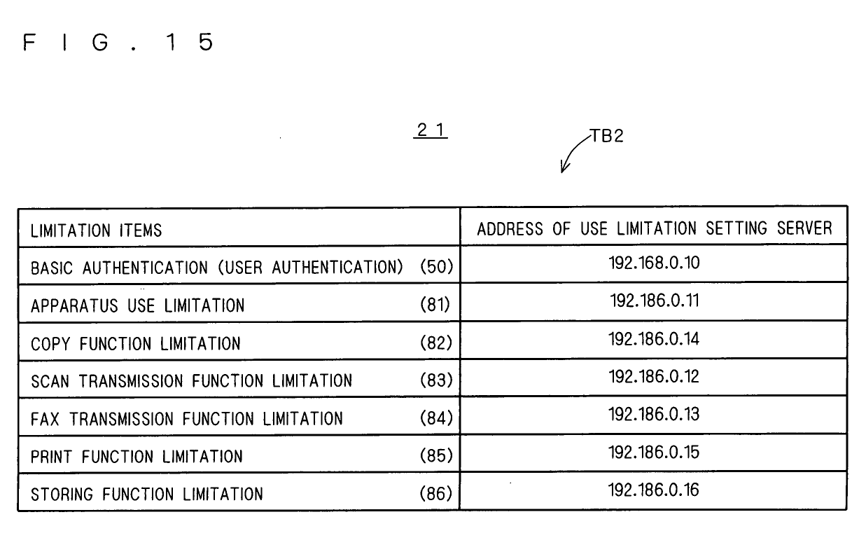

FIG. 14 is a schematic view showing a general configuration of an image forming system 1B according to the second preferred embodiment. The system 1B includes the authentication server 50 (also referred to as a basic authentication server), a plurality of MFPs 10, and a plurality of computers 70 and, in addition, a plurality of use-limitation-setting-servers (hereinafter, also simply referred to as “setting servers”) 80 (81 to 86). The MFPs 10, authentication server 50, the computers 70 and the setting servers 80 are connected to each other via the network NW.

The MFP 10, the authentication server 50 and the computer 70 have configurations similar to those in the first preferred embodiment. Hereinafter, the detailed description will not be repeated but the different points will be mainly described.

In the second preferred embodiment, as described above, the use-permission-information itself is not stored in the RAM 21 of the MFP 10. The use-permission-information itself is stored so as to be spread in the setting servers 81 to 86. Concretely, the “permission-information-by-apparatus” in the use-permission-information is stored in the setting server 81 (also referred to as an apparatus-use-limitation-setting-server). The “permission-information-by-function” in the use-permission-information is stored so as to be spread in the plurality of setting servers 82 to 86. More specifically, the “copying function permission information” is stored in the copy limitation setting server 82, and the “scan function permission information” is stored in the scan limitation setting server 83. The “facsimile communication function permission information” is stored in the FAX limitation setting server 84, the “printing function permission information” is stored in the print limitation setting server 85, and the “storing function permission information” is stored in the storage limitation setting server 86.

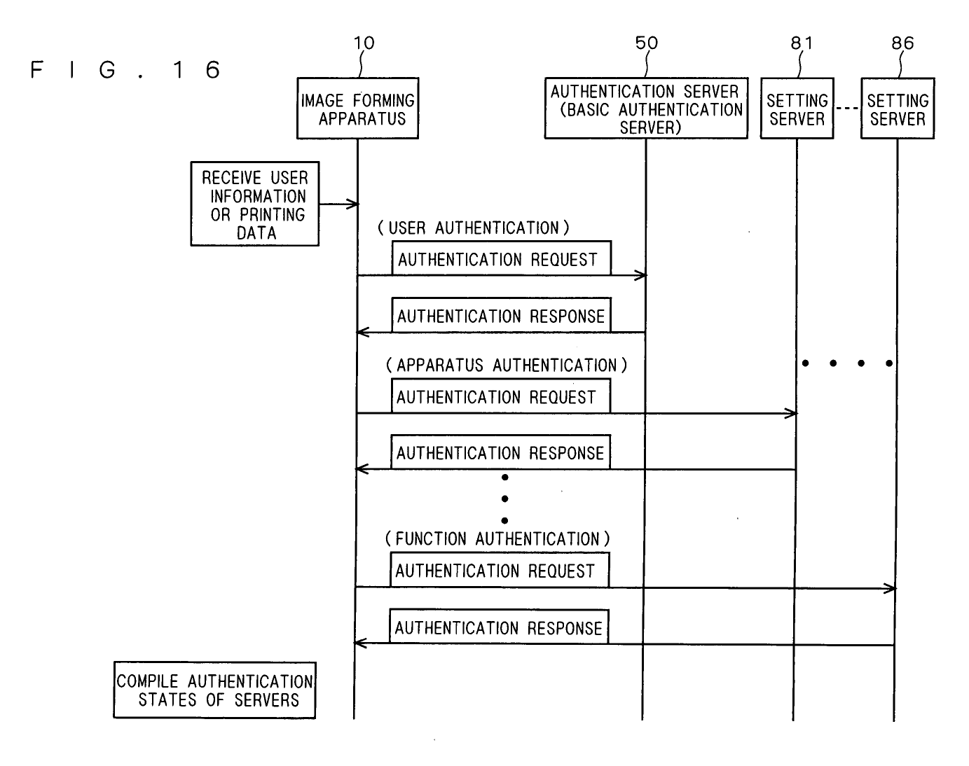

As shown in FIG. 15, storage-location-information for specifying (identifying) apparatuses (setting servers 81 to 86) storing a plurality of items of the use-permission-information is stored in the RAM 21 in the MFP 10. Concretely, as the storage-location-information, the IP addresses of the authentication server 50 and the six setting servers 81 to 86 are stored in a data table TB2 in the RAM 21.

Specifically, the IP address (in this case, 192.168.0.10) of the authentication server 50 is stored in the data table TB2. The IP address (in this case, 192.186.0.11) of the apparatus-use-limitation-setting-server 81 is also stored in the data table TB2. In the data table TB2, the IP address (in this case, 192.186.0.14) of the copy limitation setting server 82, the IP address (in this case, 192.186.0.12) of the scan limitation setting server 83, the IP address (in this case, 192.186.0.13) of the FAX limitation setting server 84, the IP address (in this case, 192.186.0.15) of the print limitation setting server 85, and the IP address (in this case, 192.186.0.16) of the storage limitation setting server 86 are also stored.

The IP addresses of the servers 50 and 80 are also registered in the data table TB2 by the administrator of each MFP 10.

The MFP 10 inquires the setting servers 81 to 86 specified by the IP addresses stored in the data table TB2 about whether the items of the use limitation information are limited or not via network communications. The MFP 10 obtains the “use-permission-information” by communication with the setting servers 81 to 86 via a network and determines permission/prohibition of the use on the apparatus unit basis and the function unit basis on the basis of the contents of the obtained “use-permission-information”.

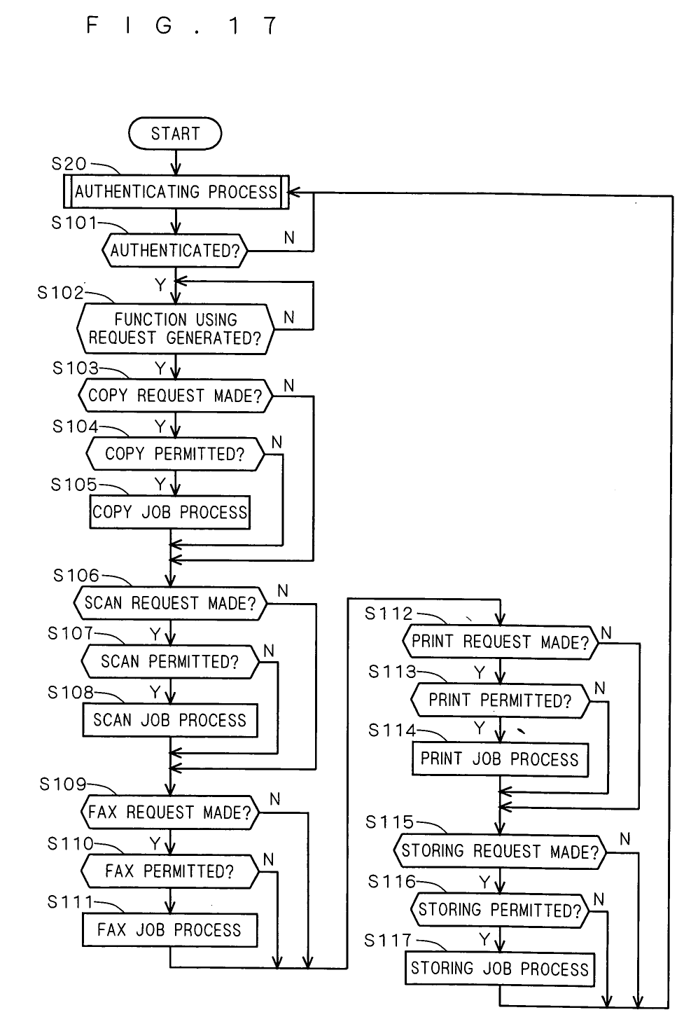

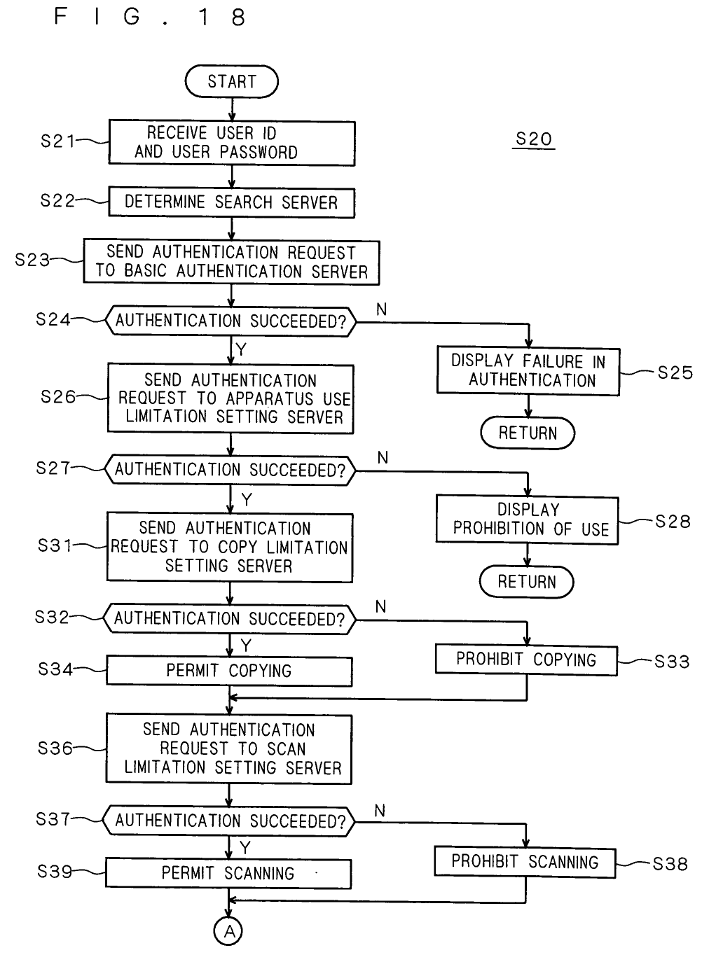

In the following, the operation performed when the user actually uses various functions (such as the copying function) of the MFP 10 in the system 1B according to the second preferred embodiment will be described with reference to FIGS. 16 to 19. FIG. 16 is an operation diagram showing transmission/reception of information among the MFP 10, the authentication server 50 and the setting servers 80. FIGS. 17 to 19 are flowcharts showing the operation of the MFP 10.

It is assumed herein that the work of registration of the user authentication information to the authentication server 50 and registration of the use-permission-information to the setting servers 81 to 86 is finished prior to the use operation. In the following, prior to description of the operation shown in FIGS. 17 to 19, the operation of registering various information will be described.

Registration of the user authentication information is similar to that of the first preferred embodiment. An operation of registering the user authentication information to the authentication server 50 is performed by the administrator of the entire system.

A work of registering information to the setting servers 81 to 86 is performed by the respective administrators of the setting servers 81 to 86.

Concretely, the administrator of the setting server 81 sets the setting information regarding permission and prohibition of the use of the whole apparatus of each MFP 10 for each of the users. In the storing part of the setting server 81, the setting information (for example, flag information such as “1” and “0”) regarding permission and prohibition of the use of the whole apparatus of each MFP 10 is set and stored for each user ID.

Similarly, the administrator of the setting server 82 sets setting information (use-permission-information) regarding permission and prohibition of the use of the copying function of each MFP 10 for each user. In the storing part of the setting server 82, the setting information (for example, flag information such as “1” and “0”) regarding permission and prohibition of the use of the copying function of each MFP 10 is set and stored for each user ID.

In each of the other setting servers 83 to 86 as well, information to be managed by the setting server is registered by the respective administrator.

In the case where a plurality of MFPs 10 exist, the use-permission-information is set for each of the MFPs in each of the server 50 and the servers 81 to 86. In this case, the MFPs 10 are discriminated from each other by the IP addresses (or MFP numbers).

The using operation of the MFP 10 subsequent to the registering operation will now be described.

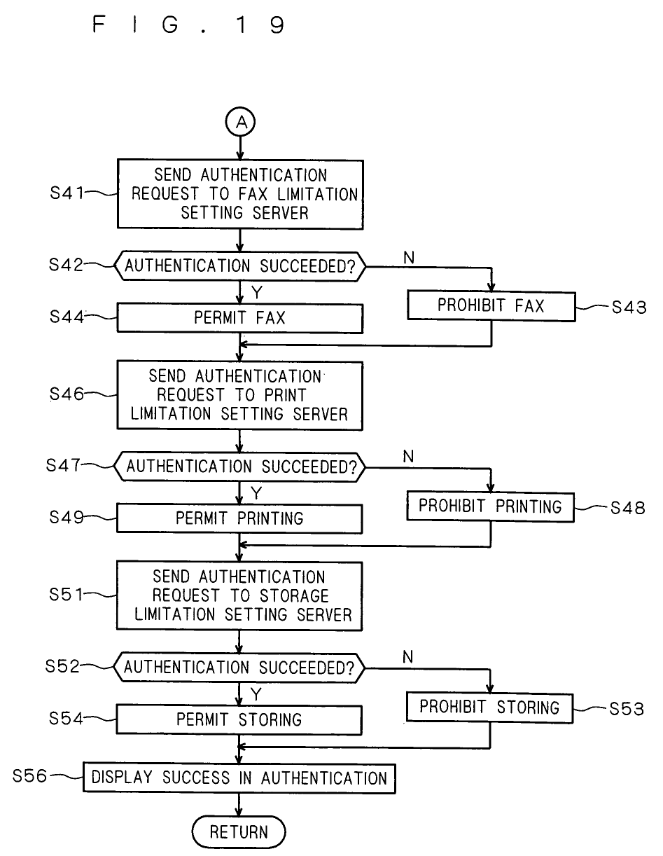

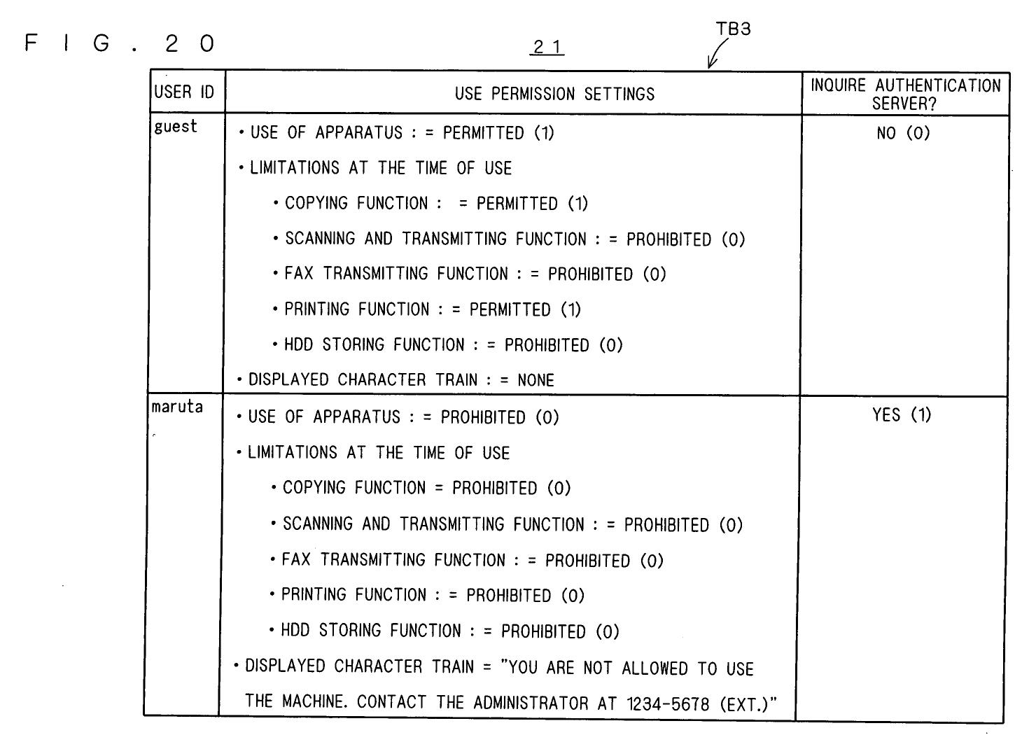

The main flowchart of FIG. 17 will be referred to. First, in step S20, authenticating operation is performed. The authenticating operation is described in detail in the flowcharts of FIGS. 18 and 19.

First, in step S21 (FIG. 18), an input of user ID and a user password is accepted. In step S21, a process similar to that of step S11 is performed.

In step S22, the MFP 10 searches the data table TB2 and determines the authentication server 50 and the setting servers 81 to 86 as destinations. Concretely, the MFP 10 retrieves the identification information (IP addresses) of the server 50 and the servers 81 to 86 in which the settings of the items of the use-permission-information are stored, and specifies the server 50 and the servers 81 to 86. More specifically, the MFP 10 reads the IP address (192.168.0.10) of the authentication server 50 from the data table TB2 on the inside to specify the authentication server 50. The MFP 10 reads the IP address (192.186.0.11) of the setting server 81 and specifies the setting server 81. Similarly, the MFP 10 reads the IP addresses of the other setting servers 82 to 86 and specifies the setting servers 82 to 86, respectively.

In step S23, the MFP 10 transmits an “authentication request” to the authentication server 50. In steps S23, S24 and S25, processes similar to those of steps S12, S13 and S14 are performed, respectively.

The authentication server 50 receives the “authentication request” and, then, performs the authenticating operation. The authentication server 50 determines whether the user is an authorized user or not by checking the user information (input user ID and input user password) sent from the MFP 10 against the user authentication information stored in the authentication server 50 and transmits the authentication result to the MFP 10 (authentication response) (also see FIG. 16).

The MFP 10 receives the authentication result and performs the branching process (step S24). When the authentication fails, the MFP 10 advances to step S25 (display of failure in authentication). When the authentication succeeds, the MFP 10 advances to step S26.

In steps S26, S27 and S28, the information (permission-information-by-apparatus) regarding the use permission on the apparatus unit basis with respect to the user is received from the setting server 81 and an operation of setting use limit on the apparatus unit basis of the MFP 10 is performed.

In step S26, the MFP 10 transmits the “authentication request” for the use of the whole apparatus to the setting server 81 (also see FIG. 16). The “authentication request” to the setting server 81 includes instruction data requesting for authentication and, in addition, user information of the authorized user (concretely, the input user ID which is input in step S21) and apparatus identification information (the IP address, the MFP number or the like) of the MFP 10.

The setting server 81 receives the “authentication request” and performs the authenticating operation. The setting server 81 reads setting information regarding whether the use of the whole apparatus (MFP 10) is permitted to the user or not on the basis of the input user ID and the apparatus identification information of the MFP 10 sent from the MFP 10 and, in accordance with the setting information, determines whether authentication succeeds or not. To be concrete, if the setting information is set as “permitted”, the setting server 81 sends the authentication result of “success in authentication” to the MFP 10. If the setting information is set as “prohibited”, the setting server 81 sends the authentication result of “failure in authentication” to the MFP 10.

On receipt of the authentication result, the MFP 10 performs the branching process (step S27) and advances to step S28 when the authentication fails and advances to step S31 when the authentication succeeds. In step S28, a process similar to that of step S18 is performed.

In step S31 and subsequent steps, the use-permission-information of each function (permission-information-by-function) of the user is received from each of the servers and an operation of setting the use limit of the MFP 10 on the function-by-function unit basis is performed.

First, in steps S31 to S34, a setting operation regarding permission/prohibition of the use of the copying function is performed.

Concretely, in step S31, the MFP 10 transmits the “authentication request” regarding the use of the copying function of the apparatus to the setting server 82 (also see FIG. 16). The “authentication request” to the setting server 82 includes instruction data requesting authentication and, in addition, the user information of the authorized user (concretely, the input user ID which is input in step S21) and the apparatus identification information (IP address, MFP number or the like) of the MFP 10.

The setting server 82 receives the “authentication request” and performs the authenticating operation. The setting server 82 reads setting information regarding whether the use of the copying function of the apparatus (MFP 10) is permitted to the user or not on the basis of the input user ID and the apparatus identification information of the MFP 10 sent from the MFP 10 and, in accordance with the setting information, determines success or failure in the authentication. To be concrete, when the setting information is set as “permitted”, the setting server 82 sends the authentication result of “success in authentication” to the MFP 10. On the other hand, when the setting information is set as “prohibited”, the setting server 82 sends the result of authentication of “failure in authentication” to the MFP 10.

On receipt of the authentication result, the MFP 10 performs the branching process (step S32) and advances to step S33 when the authentication fails or advances to step S34 when the authentication succeeds. In step S33, the MFP 10 sets the use condition of the apparatus so as to “prohibit” the use of the copying function. On the other hand, in step S34, the MFP 10 sets the use condition of the apparatus so as to “permit” the use of the copying function. After step S33 or S34, the MFP 10 advances to step S36.

Similarly, in the following steps S36 to S39, a setting operation regarding permission/prohibition of the use of the scanning function is performed. In steps S36 to S39, operations similar to those of steps S31 to S34 are performed, respectively, except for the points that the destination of the authentication request is the “setting server 83” and whether the “scanning function” can be used or not is set by the MFP 10 on the basis of an authentication result of the setting server 83.

Similarly, in the following steps S41 to S44, a setting operation regarding whether permission/prohibition of the use of the facsimile communication function is performed. In steps S41 to S44, operations similar to those of steps S31 to S34 are performed, respectively, except for the points that the destination of the authentication request is the “setting server 84” and whether the “facsimile communication function” can be used or not is set by the MFP 10 on the basis of the result of authentication by the setting server 84.

Similarly, in the following steps S46 to S49, a setting operation regarding permission/prohibition of the printing function is performed. In steps S46 to S49, operations similar to those of steps S31 to S34 are performed, respectively, except for the points that the destination of the authentication request is the “setting server 85” and whether the “printing function” can be used or not is set by the MFP 10 on the basis of the result of authentication by the setting server 85.

Similarly, in the following steps S51 to S54, a setting operation regarding permission/prohibition of the storing function is performed. In steps S51 to S54, operations similar to those of steps S31 to S34 are performed, respectively, except for the points that the destination of the authentication request is the “setting server 86” and whether the “storing function” can be used or not is set by the MFP 10 on the basis of the result of authentication by the setting server 86.

After that, in step S56, success in authentication is displayed. The display is similar to that (see FIG. 12) of step S16 (FIG. 7).

By operations as described above, settings regarding the use limitation of the authorized user in the MFP 10 are completed.

After that, the user selects a desired function by clicking any of the function selection buttons 111 to 115 in accordance with the display of authentication success.

After that, processes in steps S101 to S117 are executed. The processes are processes similar to those of the first preferred embodiment (see FIG. 6). In the processes, the user properly inputs required information in accordance with various instructions displayed on the display 12, and the MFP 10 executes the function according to the input on the basis of the input information.

As described above, the system 1B according to this preferred embodiment can perform user authentication by using the authentication server 50 and also determine permission/prohibition of the use regarding the MFP 10 on the basis of the “use-permission-information” stored in each of the setting servers 80. Concretely, by performing the registering operation by using the setting servers 80, a setting regarding use permission or the like of each MFP 10 can be made. In particular, by using the setting servers 80 capable of making a setting of a relatively low-order level (or local level), as compared with the case of making a setting by using the authentication server 50 as a management server of a high-order level, a registration setting work can be performed more easily. Thus, the system 1B can be operated more flexibly.

Although the case where the IP addresses of all of the setting servers 81 to 86 are registered (stored) is described here, the present invention is not limited to the case and the IP addresses may remain unset. In this case, for example, use limits are not imposed on servers whose IP addresses are not set. More specifically, in the case where the IP address of the setting server 82 regarding the copy function limit is unset, the MFP 10 may permit all of the authorized users to which the use permission on the apparatus unit basis of the MFP 10 is given to use the copying function.

C. Third Preferred Embodiment

A third preferred embodiment is a modification of the first preferred embodiment. In the first preferred embodiment, the case of performing the user authentication by always using the authentication server 50 has been described. In the third preferred embodiment, the case where the user authentication using the authentication server 50 can be omitted according to the setting of the MFP 10 will be described. In such a manner, more flexibly operation can be performed.

An image forming system 1C according to the third preferred embodiment has a configuration similar to that of the image forming system 1A according to the first preferred embodiment.

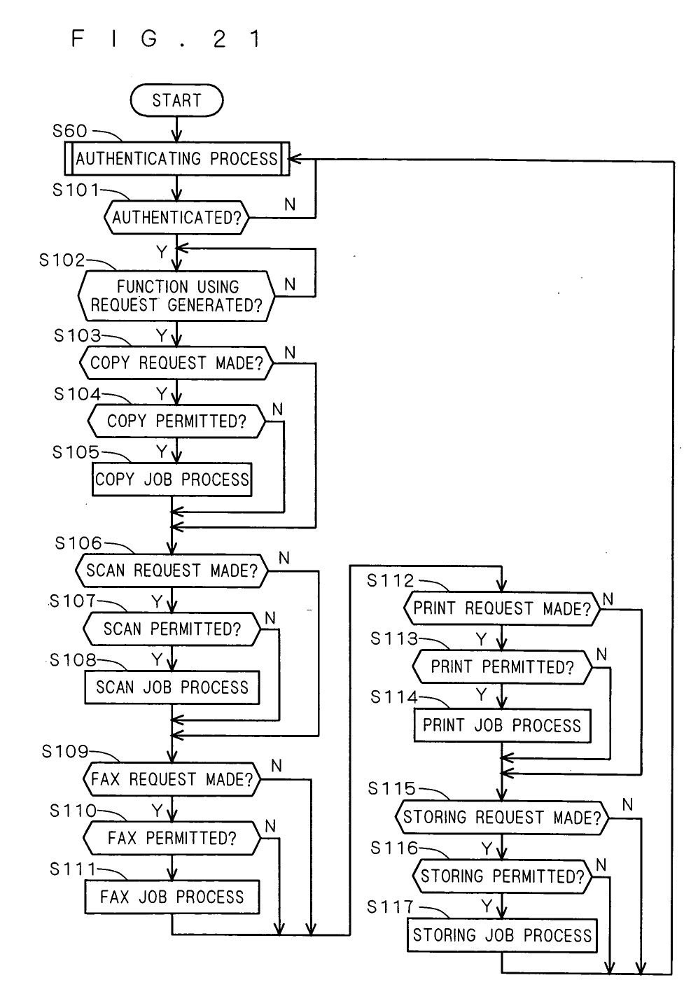

In the RAM 21 of each MFP 10, a data table TB3 is stored in place of the data table TB1. FIG. 20 is a diagram showing an example of registration of the data table TB3.

As understood from comparison with the data table TB1 (FIG. 5), in the data table TB3, setting information of whether an inquiry for user authentication is to be sent to the authentication server 50 or not is also set for each user ID. In other words, setting information of whether user authentication is to be performed or not is set as “use-permission-information” for each user. The setting information of whether user authentication is to be performed or not is stored as flag information (hereinafter, also referred to as “inquiry flag”) indicative of “1” (which means “to send an inquiry” (“to perform user authentication”)) or “0” (which means “not to send an inquiry” (not to perform user authentication”)).

For example, in FIG. 20, no inquiry to the authentication server 50 is set for the user ID “guest”. Therefore, a user who is not registered in the authentication server 50 can log in with the user ID “guest”. For the user who logged in with the user ID “guest”, use limits of various functions are set on the basis of the contents set in the data table TB3. FIG. 20 shows a case of setting so that the use of the copying function and the printing function is permitted and the use of the scanning function, facsimile communication function, and storing function is prohibited.

Consequently, for example, when a person who does not use so frequently (such as a person visiting for a short period) can use part (or all) of the functions of the MFP 10 by using the user ID “guest”. In this case, it is unnecessary to register the person as a user into the authentication server 50 so as to prepare for the use of a person who does not use so frequently, and only settings on the MFP 10 are sufficient. Therefore, the burden on the administrator of the authentication server 50 is lessened and the operation can be performed more flexibly.

Alternatively, a temporary user who intends to become an authorized user can use part (or all) of the functions of the MFP 10 by using the user ID “guest”. In this case, it becomes unnecessary to register a temporary user who intends to become an authorized user in the authentication server 50. Therefore, the burden on the authentication server 50 is lessened and an operation can be performed more flexibly.

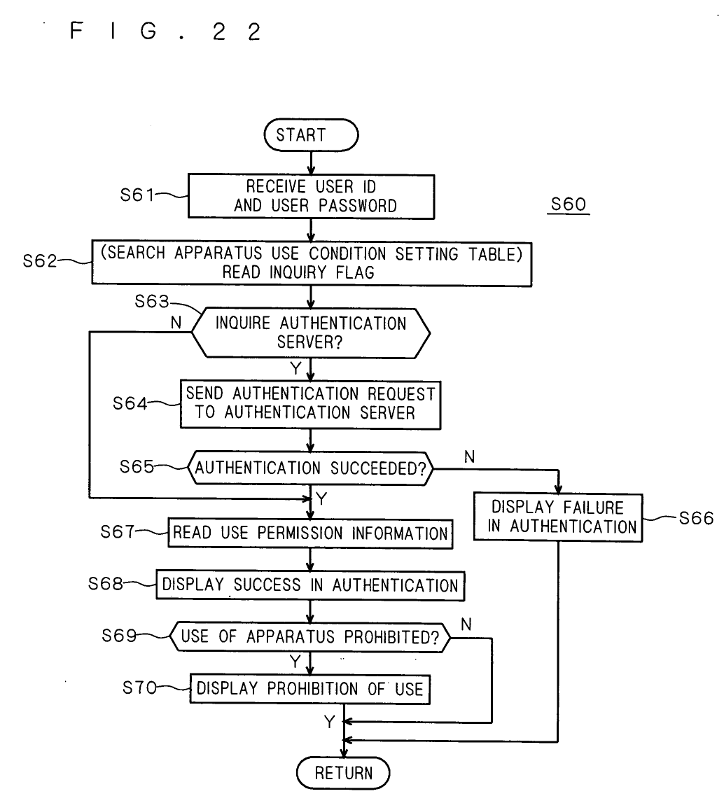

In the following, with reference to FIGS. 21 and 22, the operation performed when the user actually uses various functions (such as the copying function) of the MFP 10 in the system 1C according to the third preferred embodiment will be described. FIGS. 21 and 22 are flowcharts showing the operation of the MFP 10 according to the third preferred embodiment.

The main flowchart of FIG. 21 will be referred to. First, an authentication operation is performed in step S60. The authentication operation is described in detail in the flowchart of FIG. 22.

First, in step S61 (FIG. 22), an input of user ID and a user password is accepted. In step S61, a process similar to that of step S11 is performed.

In step S62, the value of the inquiry flag to the authentication server 50 in the use-permission-information corresponding to the user ID which is input in step S61 is retrieved from the RAM 21 and is read out.

A branching process (step S63) according to the value of the inquiry flag is performed.

In the case where the data indicative of making an inquiry to the authentication server 50 (performing user authentication) is read, an authentication request to the authentication server 50 is transmitted (step S64). In step S64, a process similar to that in step S12 (FIG. 7)is performed. The authentication server 50 receives the “authentication request”, performs the authenticating operation, and sends the result (result of authentication) to the MFP 10.

After that, in the MFP 10, an operation according to the authentication result from the authentication server 50 is performed (steps S65 to S68). The processes in steps S65, S66, S67, S68, S69 and S70 are similar to those in the steps S13, S14, S15, S16, S17 and S18, respectively.

As described above, with respect to a user to be subjected to user authentication (also referred to as “authentication necessary user”), under condition that the user is to succeed in user authentication, whether the use of the MFP 10 can be permitted or not is determined on the basis of the use-permission-information in the data table TB3.

In the case where data indicating that no inquiry is sent to the authentication server 50 (user authentication is not performed) is read, without transmitting the authentication request to the authentication server 50, the MFP 10 advances to step S67. In other words, the authentication part 31 does not perform user authentication using the authentication server 50 for a user who is set as a user not subjected to user authentication (also referred to as “authentication unnecessary user”) in the setting information of the data table TB3.

In steps S67, S68, S69 and S70, processes similar to those in steps S15, S16, S17 and S18 are performed, respectively. According to the data in the data table TB3, a process of determining permission/prohibition of the use on the apparatus-by-apparatus unit basis or the function-by-function unit basis regarding the MFP 10 is performed. That is, with respect to the “authentication unnecessary user”, the operation permission determining part 32 determines permission/prohibition of the use regarding the MFP 10 by the authentication unnecessary user on the basis of the use-permission-information in the data table TB3 without requiring success in the user authentication as a condition.

After that, referring again to FIG. 21, the operations of steps S101 to S117 are performed. By the operations, permission/prohibition of the use of each function is determined on the basis of settings of the use-permission-information. On the basis of the result of determination, whether the function is executed or not is determined.

As described above, the system 1C according to the third preferred embodiment can obtain advantages similar to those of the first preferred embodiment. In addition, the use of the MFP 10 can be permitted to the authentication unnecessary user on the basis of the “use-permission-information” stored in the RAM 21 in the MFP 10 without using user authentication, so that the flexibility is high.

D. Others

Although the foregoing preferred embodiments have been described that each of the functions is executed by itself, the present invention is not limited to the preferred embodiments. For example, the idea can be applied also to the case of executing a combination of an arbitrary number of plural functions including the copying function, the scanning function, the facsimile communication function, the printing function and the memory storing function. Concretely, by combining the scanning function and the storing function, a function of storing image data generated by reading an original on a document glass into the hard disk 231 of the MFP 10 is realized. It is sufficient to determine a function realized by combining a plurality of functions on assumption that the use of all of the functions employed to the combination is permitted. For example, it is sufficient to use a function realized by combining the scanning function and the storing function (such as a “scan to HDD” function for storing a scanned image generated by the scanning function into the hard disk 231) as follows. Concretely, it is sufficient to confirm permission of the use of the scanning function in step S107 (FIG. 6) and, after that, permission of the use of the storing function in step S108 and perform the actual “scan to HDD” operation. Alternatively, after step S117 or the like, a routine for determining whether each combination of functions can be executed or not is separately provided after step S117 or the like and, according to the result of determination, the actual combining operation may be executed.

The functions of each of the image forming apparatuses are not limited to the five functions. For example, the above idea can be applied also to a mail transmitting function. Alternatively, information determining whether each of sub functions of the above-described functions can be permitted or not may be included in the use-permission-information. For example, the copying function may be divided into two sub functions of a color copying function and a monochrome copying function and information determining whether each of the sub functions can be permitted or not may be stored in the data table TB1 in the MFP 10.

Although the case where all the image forming apparatuses have the same functions has been described in the foregoing preferred embodiments, the present invention is not limited to the case. Concretely, the image forming apparatuses may have different functions. For example, in the first preferred embodiment, the MFPs 10 may have different functions. To be specific, the first MFP 10 may have five functions as described above and the second MFP 10 may have four functions out of the five functions except for the storing function. In this case, it is sufficient to store the permission-information-by-function for each of the five functions in the data table TB1 in the first MFP 10 and to store the permission-information-by-function for each of the four functions in the data table TB1 in the second MFP 10. As described above, the use-permission-information can be set on the function-by-function unit basis of each MFP 10 in accordance with the functions of the MFP 10 in the data table TB1 in the MFP 10.

Also in the case where a plurality of apparatuses having different kinds of functions are managed by an authentication server, by managing the permission information of each of the different kinds of functions of the apparatuses in each of the MFPs 10, the system operation can be performed more flexibly. In particular, it is unnecessary to make use settings for a function which is not provided for the MFP 10, so that the setting work can be done efficiently. For example, in the second MFP 10 which does not have the storing function as described above, it is unnecessary to perform the setting registering work regarding the storing function. Thus, the registering work can be performed efficiently.

Although the MFP 10 having a plurality of functions has been described as an image forming apparatus in the foregoing preferred embodiments, the present invention is not limited to the MFP 10. The present invention can be also applied to, for example, an image forming apparatus having a single function.

Although an IP address or the like is taken as an example of identification information in each of the foregoing preferred embodiments, the identification information is not limited to the IP address but may be an MAC address, a computer name or the like.

While the invention has been shown and described in detail, the foregoing description is in all aspects illustrative and not restrictive. It is therefore understood that numerous modifications and variations can be devised without departing from the scope of the invention.

What is claimed is:

1. An image forming apparatus comprising:
an authentication part which performs user authentication by communicating with an authentication server;
a storing part which stores use-permission-information for setting permission and/or prohibition of use of said image forming apparatus for each user; and
a determining part which determines permission and/or prohibition of the use of the image forming apparatus by a user authorized by said authentication part on the basis of said use-permission-information stored in said storing part.

2. The image forming apparatus according to claim 1, wherein
said use-permission-information includes permission-information-by-function, for setting permission and/or prohibition of the use of said image forming apparatus by each of users on a function-by-function unit basis.

3. The image forming apparatus according to claim 2, wherein
said permission-information-by-function includes information regarding permission and/or prohibition of the use of at least one of a copying function, a scanning function, a facsimile communication function, a printing function and a memory storing function.

4. The image forming apparatus according to claim 1, wherein
said use-permission-information includes permission-information-by-apparatus, for setting permission and/or prohibition of the use of said image forming apparatus by each of users on an apparatus-by-apparatus unit basis.

5. The image forming apparatus according to claim 1, wherein
said use-permission-information further includes setting information for setting whether said user authentication is to be performed or not user by user,
said authentication part does not perform said user authentication for an authentication unnecessary user who is set as a user not subjected to said user authentication in said setting information, and
said determining part determines permission and/or prohibition of the use of the image forming apparatus by the authentication unnecessary user on the basis of said use-permission-information stored in said storing part without regard to success in said user authentication.

6. An image forming apparatus comprising:
an authentication part which performs user authentication by communicating with an authentication server;
a storing part which stores storage-location-information specifying at least one storing apparatus in which use-permission-information for setting permission and/or prohibition of use of said image forming apparatus for each user is stored;
an acquiring part which acquires said use-permission-information by communication with said at least one storing apparatus specified on the basis of said storage-location-information; and
a determining part which determines permission and/or prohibition of the use of the image forming apparatus by a user authorized by said authentication part on the basis of said use-permission-information acquired from said at least one storing apparatus.

7. The image forming apparatus according to claim 6, wherein
said at least one storing apparatus has a plurality of storing apparatuses,
said use-permission-information includes a plurality of pieces of permission-information-by-function, which sets permission and/or prohibition of the use of said image forming apparatus by each of users on a function-by-function unit basis,
said plurality of pieces of permission-information-by-function are stored so as to be spread in said plurality of storing apparatuses, and
said storage-location-information includes address information of said plurality of storing apparatuses.

8. The image forming apparatus according to claim 7, wherein
said plurality of pieces of permission-information-by-function include information regarding permission and/or prohibition of the use of any of a copying function, a scanning function, a facsimile communication function, a printing function and a memory storing function.

9. The image forming apparatus according to claim 6, wherein
said use-permission-information includes permission-information-by-apparatus, which sets permission and/or prohibition of the use of said image forming apparatus by each user on an apparatus-by-apparatus unit basis,
said permission-information-by-apparatus is stored in an apparatus-use-limitation-server as one of said at least one storing apparatus, and
said storage-location-information includes address information of said apparatus-use-limitation-server.

10. An image forming system comprising:
an image forming apparatus; and
an authentication server capable of performing communication with said image forming apparatus, wherein
said image forming apparatus includes:
an authentication part which performs user authentication by communicating with said authentication server;
a storing part which stores use-permission-information for setting permission and/or prohibition of use of said image forming apparatus for each user; and
a determining part which determines permission and/or prohibition of the use of the image forming apparatus by a user authorized by said authentication part on the basis of said use-permission-information stored in said storing part.

11. The image forming system according to claim 10, wherein
said use-permission-information includes permission-information-by-function, which sets permission and/or prohibition of the use of said image forming apparatus by each of users on a function-by-function unit basis.

12. The image forming system according to claim 11, wherein
said permission-information-by-function includes information regarding permission and/or prohibition of the use of at least one of a copying function, a scanning function, a facsimile communication function, a printing function and a memory storing function.

13. The image forming system according to claim 10, wherein
said use-permission-information includes permission-information-by-apparatus, which sets permission and/or prohibition of the use of said image forming apparatus by each of users on an apparatus-by-apparatus unit basis.

14. The image forming system according to claim 10, wherein
said use-permission-information further includes setting information for setting whether said user authentication is to be performed or not user by user,
said authentication part does not perform said user authentication for an authentication unnecessary user who is set as a user not subjected to said user authentication in said setting information, and
said determining part determines permission and/or prohibition of the use of the image forming apparatus by the authentication unnecessary user on the basis of said use-permission-information stored in said storing part without regard to success in said user authentication.

15. An image forming system comprising:
an image forming apparatus;
an authentication server capable of performing communication with said image forming apparatus; and
at least one storing apparatus for storing use-permission-information for setting permission and/or prohibition of said image forming apparatus user by user, wherein
said image forming apparatus includes:
an authentication part which performs user authentication by communicating with said authentication server;
a storing part which stores storage-location-information specifying said at least one storing apparatus;
an acquiring part which acquires said use-permission-information by communication with said at least one storing apparatus specified on the basis of said storage-location-information; and
a determining part which determines permission and/or prohibition of the use of the image forming apparatus by a user authorized by said authentication part on the basis of said use-permission-information acquired from said at least one storing apparatus.

16. The image forming system according to claim 15, wherein
said at least one storing apparatus has a plurality of storing apparatuses,
said use-permission-information includes a plurality of pieces of permission-information-by-function, which sets permission and/or prohibition of the use of said image forming apparatus by each of users on a function-by-function unit basis,
said plurality of pieces of permission-information-by-function are stored so as to be spread in said plurality of storing apparatuses, and
said storage-location-information includes address information of said plurality of storing apparatuses.

17. The image forming system according to claim 16, wherein
said plurality of pieces of permission-information-by-function include information regarding permission and/or prohibition of the use of any of a copying function, a scanning function, a facsimile communication function, a printing function, and a memory storing function.

18. The image forming system according to claim 15, wherein
said use-permission-information includes permission-information-by-apparatus, which sets permission and/or prohibition of the use of said image forming apparatus by each user on an apparatus-by-apparatus unit basis,
said permission-information-by-apparatus is stored in an apparatus-use-limitation-server as one of said at least one storing apparatus, and
said storage-location-information includes address information of said apparatus-use-limitation-server.

19. An image forming method comprising the steps of:
a) storing use-permission-information for setting permission and/or prohibition of use of an image forming apparatus for each user into the image forming apparatus;
b) performing user authentication by communicating with an authentication server; and
c) determining permission and/or prohibition of the use of said image forming apparatus by a user authorized in said step (b) on the basis of said use-permission-information stored in said image forming apparatus.

20. An image forming method comprising the steps of:
a) storing storage-location-information for specifying at least one storing apparatus in an image forming apparatus, in said at least one storing apparatus, use-permission-information for setting permission and/or prohibition of use of said image forming apparatus for each user being stored;
b) performing user authentication by communicating with an authentication server;
c) acquiring said use-permission-information by communication with said at least one storing apparatus specified on the basis of said storage-location-information; and
d) determining permission and/or prohibition of the use of said image forming apparatus by a user authorized in said step b) on the basis of said use-permission-information acquired in said step c).

21. An image forming system comprising:
a plurality of image forming apparatuses having functions different from each other; and
an authentication server capable of performing communication with said plurality of image forming apparatuses, wherein
each of said plurality of image forming apparatuses includes:
an authentication part which performs user authentication by communicating with said authentication server;
a storing part which stores use-permission-information for setting permission and/or prohibition of use of said image forming apparatus for each user, said use-permission-information including permission-information-by-function for setting permission and/or prohibition of the use of each of the functions of the apparatus function by function of said apparatus; and
a determining part which determines permission and/or prohibition of the use of the apparatus by a user authorized by said authentication part on the basis of said use-permission-information stored in said storing part.
